(19) United States
(12) Patent Application Publication
(10) Pub. No.: US 2024/0116070 A1
(43) Pub. Date: Apr. 11, 2024

(54) ROAD ADHESIVE PRIMER SPRAY APPLICATOR

(71) Applicant: CORNING RESEARCH & DEVELOPMENT CORPORATION, Corning, NY (US)

(72) Inventors: Brian Matthew Cole, Austin, TX (US); David Montalion Dupuis, Cedar Park, TX (US); Cary Alan Kipke, Pflugerville, TX (US); Donald Kent Larson, Cedar Park, TX (US)

(21) Appl. No.: 18/545,146

(22) Filed: Dec. 19, 2023

Related U.S. Application Data
(63) Continuation of application No. PCT/US2022/035621, filed on Jun. 30, 2022.
(60) Provisional application No. 63/217,411, filed on Jul. 1, 2021.

(51) Int. Cl. B05B 13/00; B05B 13/02

(52) U.S. Cl. CPC B05B 13/005; B05B 13/0278

(57) ABSTRACT

Embodiments of the disclosure relate to an applicator for an adhesive primer. The applicator includes a tank configured to hold the adhesive primer. The applicator also includes a peristaltic pump, having an inlet and an outlet, and a spray nozzle. A first conduit extends from an interior of the tank to the inlet of the peristaltic pump, and a second conduit extends from an outlet of the peristaltic pump to the spray nozzle. Embodiments of the present disclosure also relate to a method of applying adhesive primer to a road surface using the applicator. In the method, the adhesive primer is pumped from the tank containing the adhesive primer through the peristaltic pump to the spray nozzle. Further, the adhesive primer is sprayed from the spray nozzle onto the road surface while the applicator moves across the road surface.

### CROSS-REFERENCE TO RELATED APPLICATION

This application is a continuation of International Patent Application No. PCT/US20221035621, filed Jun. 30, 2022, which claims the benefit of priority under 35 U.S.C. § 119 of U.S. Provisional Application Ser. No. 63/217,411, filed on Jul. 1, 2021, the content of which is relied upon and incorporated herein by reference in its entirety.

### BACKGROUND

The disclosure relates generally to equipment involved in the installation of optical fiber cables in roadways and more particularly to an applicator and method of applying road adhesive primer to a road surface. Optical fibers are used to transmit data optically between various points in a network. Typically, deployment of an optical fiber network requires installation of optical fibers on telephone poles or in ducts below grade. Such installations are expensive, relatively slow to roll out, and labor intensive. Recently, efforts have been made to install optical fiber cables in shallow trenches in the roadway, which reduces the cost, installation time, and complexity of deploying an optical fiber network. However, various aspects of this method of optical fiber cable deployment can still be improved upon to further reduce the cost, time, and complexity involved in the operation.

### SUMMARY

According to an aspect, embodiments of the disclosure relate to an applicator for an adhesive primer. The applicator includes a tank configured to hold the adhesive primer. The applicator also includes a peristaltic pump comprising an inlet and an outlet and a spray nozzle. A first conduit extends from an interior of the tank to the inlet of the peristaltic pump, and a second conduit extends from an outlet of the peristaltic pump to the spray nozzle.

According to another aspect, embodiments of the disclosure relate to a method of applying adhesive primer to a road surface using an applicator. In one or more embodiments, the applicator includes a tank, a peristaltic pump, and a spray nozzle. In embodiments of the method, the adhesive primer is pumped from the tank containing the adhesive primer through the peristaltic pump to the spray nozzle. Further, the adhesive primer is sprayed from the spray nozzle onto the road surface while the applicator moves across the road surface.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts an adhesive spray applicator in the form of a pushable cart, according to an exemplary embodiment;

FIG. 2 depicts a rear view of the adhesive spray applicator of FIG. 1, according to another exemplary embodiment;

FIG. 3 depicts a front perspective view of the adhesive spray applicator of FIG. 1, according to an exemplary embodiment;

FIG. 4 depicts a close-up view of the spray nozzle and pump of the spray applicator of FIG. 1, according to an exemplary embodiment;

FIG. 5 depicts an embodiment of a peristaltic pump usable with embodiments of the disclosed adhesive spray applicator, according to an exemplary embodiment;

FIGS. 6 and 7 depict an adhesive spray applicator having a handheld wand detachable from the pushable cart, according to an exemplary embodiment;

FIGS. 8-10 provide graphs of spray nozzle performance, according to exemplary embodiments;

FIG. 11 depicts a handheld adhesive spray applicator, according to an exemplary embodiment; and

FIG. 12 depicts aspects of an adhesive spray applicator for use with a water-based adhesive spray, according to an exemplary embodiment.

### DETAILED DESCRIPTION

Referring generally to the figures, various embodiments of an applicator for spraying road adhesive primer and a method of applying road adhesive primer to a road surface are provided, in particular relative to the installation of optical fiber cables in shallow trenches formed in road surfaces. As will be discussed more fully below, the applicator uses a peristaltic pump to generate pulses of road adhesive primer spray that are applied to a road surface. By using a peristaltic pump, the tubing through which the road adhesive primer is carried between a storage tank and spray nozzle can be discarded after each use, which eliminates the costly and potentially hazardous use of organic solvents that would otherwise be needed to clean the system after use. Advantageously, the peristaltic pump can be configured along with the spray nozzle to drive a variable amount of road adhesive primer spray by varying the voltage used to drive the pump. In particular embodiments, the variable amount of road adhesive primer spray is based on the speed at which the applicator is moved. Exemplary embodiments of the applicator and method of using the applicator will be described in greater detail below in relation to the figures provided herewith, and these exemplary embodiments are provided by way of illustration, and not by way of limitation.

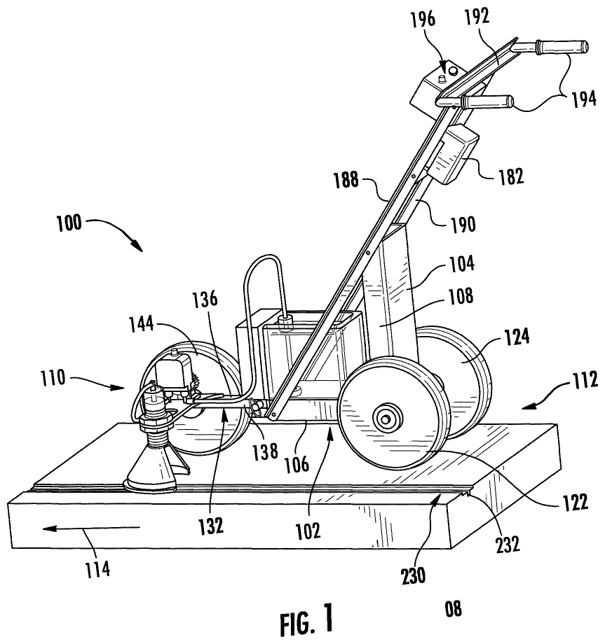

FIG. 1 depicts an exemplary embodiment of an applicator 100. The applicator 100 includes a base 102. In the embodiment depicted, the base 102 is L-shaped, having a back member 104 and a floor member 106 that are joined at a substantially perpendicular angle. In embodiments, the base 102 includes side rails 108 that extend along one or both of the back member 104 and the floor member 106. The base 102 has a first end 110 and a second end 112. The first end 110 is a front end relative to a direction of travel 114, and the second end 112 is a back end relative to the direction of travel 114. In particular, in normal operation, an operator would stand at the second end 112 of the base 102 to propel the applicator 100 in the direction of travel 114.

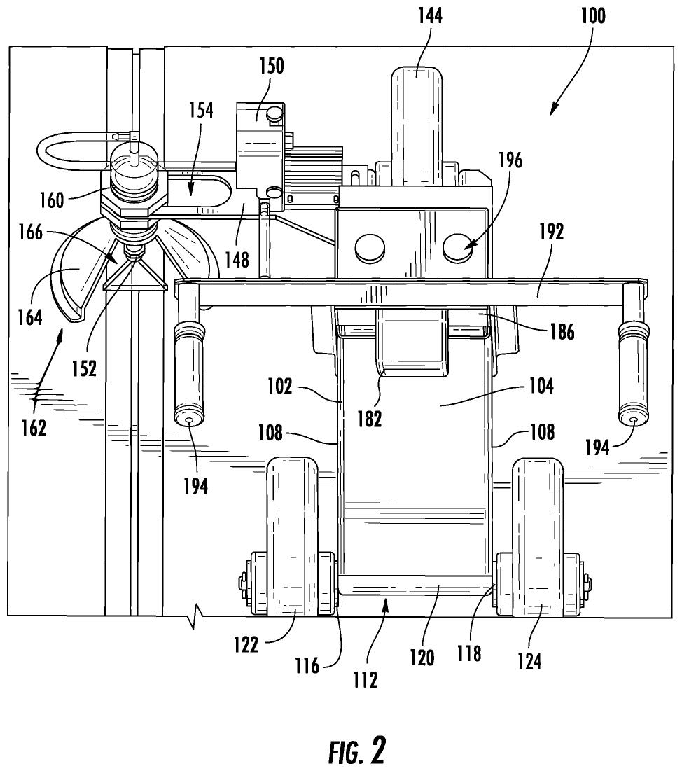

With reference now to FIG. 2, a first bracket 116 and a second bracket 118 extend from the second end 112 of the base 102. In particular, the first bracket 116 and the second bracket 118 may extend from the back member 104 or the side rails 108 thereof. The first bracket 116 and second bracket 118 are configured to hold a first axle 120 (e.g., using bearings or loosely within apertures of the brackets 116, 118). A first wheel 122 is connected to a first end of the first axle 120, and a second wheel 124 is connected to a second end of the first axle 120.

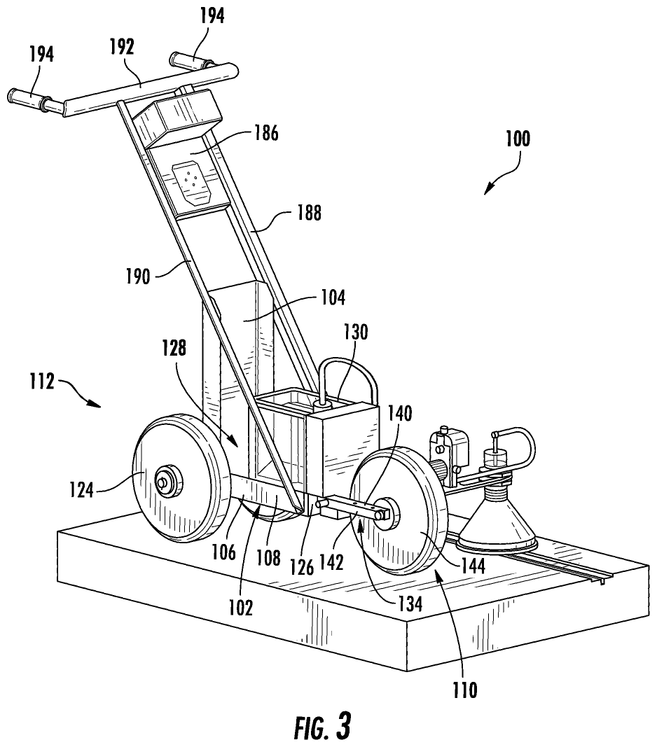

Referring now to FIG. 3, a front rail 126 extends upwardly from the floor member 106 on the first end 110 of the base 102. The front rail 126 connects the side rails 108, and the front rail 126, the side rails 108, and the back member 104 define a cavity region 128. A tank 130 for holding road adhesive primer is situated within the cavity region 128.

With reference to FIGS. 1 and 3, a first arm 132 and a second arm 134 each extend from the front rail 126. As can be seen in FIG. 1, the first arm 132 may be angle iron having a first leg 136 arranged substantially parallel to the floor member 106. A second leg 138 extends downwardly and substantially perpendicularly from the first leg 136. As can be seen in FIG. 3, the second arm 134 may also be angle iron having a third leg 140 arranged substantially parallel to the floor member 106, and a fourth leg 142 extending downwardly and substantially perpendicularly from the third leg 140. In the embodiments shown in FIGS. 1 and 3, the first arm 132 and the second arm 134 are arranged so that the downwardly extending second leg 138 and fourth leg 142 are substantially parallel and facing each other.

A third wheel 144 is disposed between the first arm 132 and the second arm 134. A second axle carries the third wheel 144. The second axle extends between the first arm 132 and the second arm 134, in particular through the second leg 138 and the fourth leg 142. The second axle may be held in apertures in the second leg 138 and fourth leg 142 or on bearings mounted in the second leg 138 and fourth leg 142.

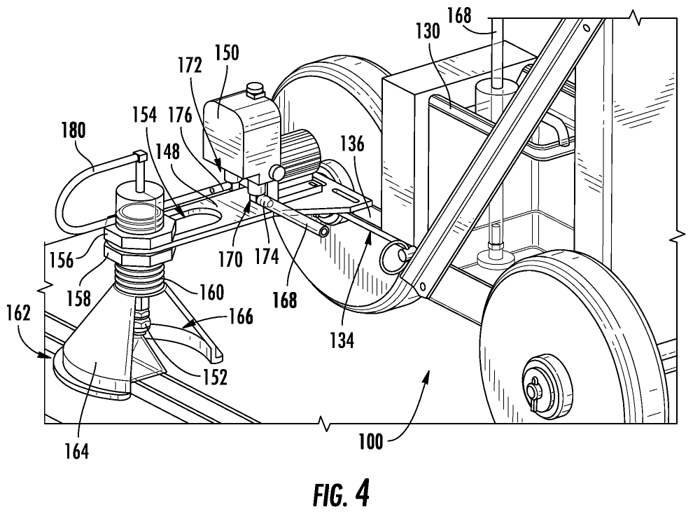

Referring now to FIG. 4, the first leg 136 of the first arm 134 provides a mounting surface for a third bracket 148. However, in other embodiments, a bracket may instead be mounted on the third leg 140 of the second arm 134, or a bracket may be mounted on each of the first leg 136 of the first arm 134 and third leg 140 of the second arm 134.

In the embodiment depicted, the third bracket 148 provides a mounting surface for a peristaltic pump 150 (also known as a “roller pump”). Further, the third bracket 148 provides a connector region for holding a spray nozzle 152. In the embodiment shown in FIG. 4, the connector region includes a slot 154 through which the spray nozzle 152 is inserted. The spray nozzle 152 is held in place using a first nut 156 above the slot 154 and a second nut 158 below the slot 154. In the embodiment shown in FIG. 4, the nuts 156, 158 are threaded onto a neck 160 of a wind guard 162. The wind guard 162 includes a partially conical wall 164 that surrounds the spray nozzle 152. The wall 164 includes a cutout region 166 through which the operator of the applicator 100 can view spraying of the primer through the spray nozzle 152. The wall 164 is connected to the neck 160, and the neck 160 is inserted through the slot 154. Thereafter, the nuts 156, 158 are tightened against the third bracket 148 to hold the wind guard 162 and spray nozzle 152 in place. By adjusting where on the neck 160 the nuts 156, 158 are located, the distance of the spray nozzle 152 to the road surface can selected. In general, positioning the spray nozzle 152 farther from the road surface will create a wider spray pattern, and positioning the spray nozzle 152 closer to the road surface will create a narrower spray pattern. Further, at a given applicator movement speed and peristaltic pump pressure, the density of primer sprayed onto the road surface will be greater the closer that the spray nozzle 152 is located to the road surface.

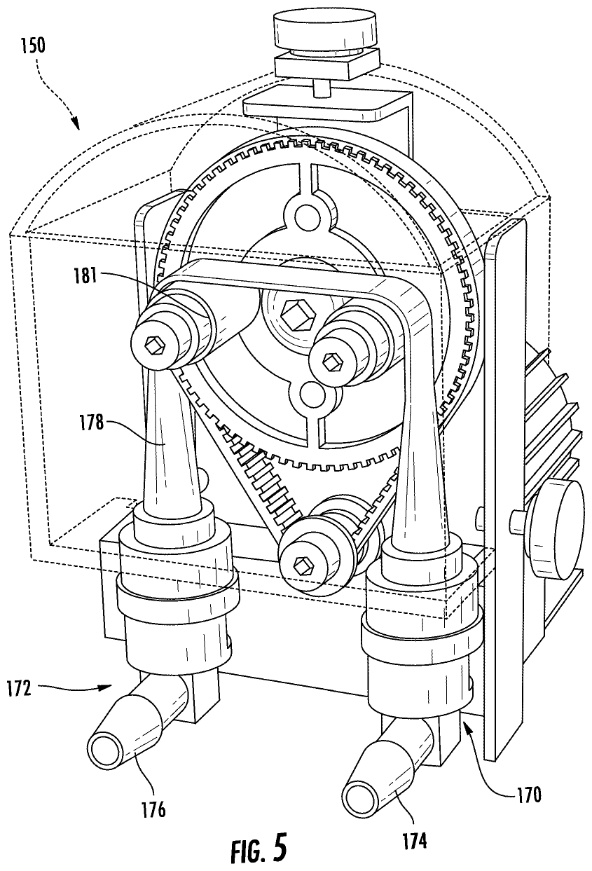

The peristaltic pump 150 draws road adhesive primer from the tank 130 through a first conduit 168 (the first conduit 168 is depicted as being discontinuous in FIG. 4 to allow a better view of the elements of the applicator shown therein, but in actuality, the first conduit 168 would be continuous between the identified ends). In the embodiment shown in FIG. 5, the peristaltic pump 150 includes an inlet 170 and an outlet 172. In one or more embodiments, the inlet 170 is fitted with a first connector 174, and the outlet 172 is fitted with a second connector 176. The first connector 174 and the second connector 176 are connected within the peristaltic pump 150 by a pump conduit 178. With reference to FIGS. 4 and 5, the first conduit 168 is attached to the first connector 174 to carry primer from the tank 130 to the inlet 170 of the peristaltic pump 150. Further, in such embodiments, a second conduit 180 is attached on one end to the second connector 176 at the outlet 172 and on the opposite end to the spray nozzle 152. Primer ejected through the outlet 172 of the peristaltic pump 150 is carried to the spray nozzle 152 through the second conduit 180.

A peristaltic pump 150 is a type of positive displacement pump used for pumping fluids. In a peristaltic pump 150, fluid (in this case primer) is contained in the pump conduit 178, and through rotary motion of the pump roller 181, the pump conduit 178 is compressed in two places. As the pump roller 181 continues to rotate, the compressed sections of the pump conduit 178 move, and the fluid trapped between the compressed sections of the pump conduit 178 moves as well. As shown in FIG. 5, the pump roller 181 will rotate to a point where the pump conduit 178 is no longer compressed, and the fluid will flow through the outlet 172 to the second conduit 180. As will be discussed more fully below, peristaltic pumps 150 have the advantage that the fluid is not in contact with any of the moving pump components, and instead, the fluid is only in contact with disposable conduit and connector parts.

In embodiments, the peristaltic pump 150 is powered by a variable voltage DC motor, which allows the applicator to be battery powered and portable. Further, in embodiments, the peristaltic pump 150 is selected for the relative ease with which the conduits 168, 178, 180 can be replaced. Further, in embodiments, the peristaltic pump 150 is selected such that it has a high enough pressure so the spray nozzle 152 generates a fan output. Further, in embodiments, it is desirable that the pump have a variable output volume to dispense a particular amount of primer per foot at a selected motive speed of the applicator 100.

In embodiments, the road adhesive primer comprises a mixture of naphtha (petroleum), hydrotreated light; n-heptane; polyterpene resin; n-butyl acetate; and optionally one or more of 3-methylhexane, methylcyclohexane, 2-methylhexane, 3-ethylpentane, and 2,3-dimethylpentane. Because of the organic solvents present in the road adhesive primer, the conduits 168, 178, 180 are selected to be compatible with the road adhesive primer. In one or more embodiments, the conduits 168, 178, 180 are comprised of at least one of silicone tubing, polyethylene tubing, nitrile rubber tubing, neoprene rubber tubing, or polytetrafluoroethylene tubing.

In one or more embodiments, the conduits 168, 178, 180 may be replaced with a single conduit that extends from the tank 130, through the peristaltic pump 150, and to the spray nozzle 152. In such embodiment, the peristaltic pump 150 would not include the first and second connectors 174, 176. Instead, the single conduit would enter through the inlet 170, wind around the pump roller 181 (shown in FIG. 5), and exit through the outlet 172.

As shown in FIGS. 1-3, the peristaltic pump 150 is powered by a battery 182. The battery 182 is inserted on a dock mounted on a panel 186 positioned between a first frame member 188 and a second frame member 190. The frame members 188, 190 are attached to opposite side rails 108 of the base 102. The frame members 188, 190 are attached to the side rails 108 of the floor member 106 and extend from the first end 110 toward and past a top portion of the back member 104 of the base 102. The frame members 188, 190 are attached to the side rails 108 of the back member 104 where the frame members 188, 190 cross the side rails 108 at the top portion. The frame members 188, 190 extend above and behind the base 102, and the panel 186 is positioned above the base 102. In embodiments, cables carrying power to the peristaltic pump 150 extend from the panel 186 down along one of the frame members 188, 190 to the peristaltic pump 150. Further, above the panel 186, a handlebar 192 extends across the frame members 188, 190. An operator of the applicator 100 can push the applicator using handles 194 of the handlebar 192.

In embodiments, the panel 186 also includes a control panel 196 that allow for the applicator 100 to be turned on/off and for the level of voltage supplied to the peristaltic pump 150 to be varied to produce variable pressurization of the primer spray and/or variable primer flow rate.

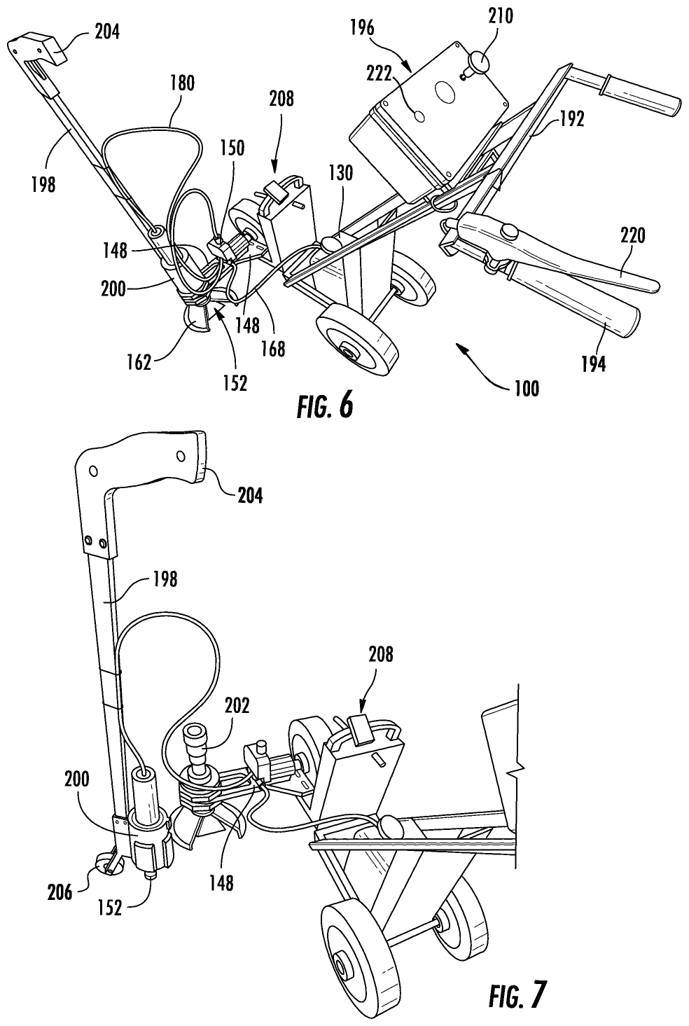

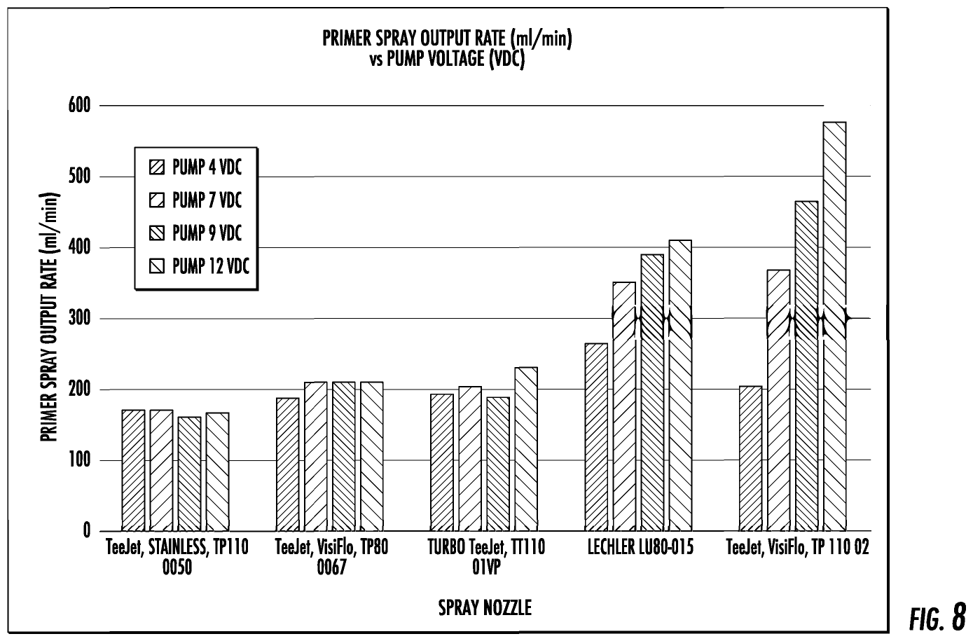

FIG. 6 depicts another embodiment of the applicator 100. In the embodiment of FIG. 6, the applicator 100 includes a spray nozzle 152 connected to a handheld wand 198. The handheld wand 198 extends upwardly from the third bracket 148. The handheld wand 198 is connected to the third bracket 148 in such a way that the handheld wand 198 is detachable from the third bracket 148. In the embodiment shown in FIG. 7, the handheld wand 198 includes a collar 200 through which the spray nozzle 152 is inserted. The third bracket 148 includes a sleeve 202 configured to hold the collar 200 of the handheld wand 198. When the handheld wand 198 is held on the third bracket 148, the spray nozzle 152 is inserted through the sleeve 202, and the collar 200 engages the sleeve 202 such that the spray nozzle 152 is held at a specified distance above the road surface. When the handheld wand 198 is detached from the third bracket 148, the handheld wand 198 is lifted, e.g., using handle 204, so that that the collar 200 disengages the sleeve 202 and the spray nozzle 152 is retracted through the sleeve 202. As shown in FIG. 7, the handheld wand 198 includes a caster 206 that can be used to roll the handheld wand 198 over the road surface while maintaining the spray nozzle 152 a predetermined distance above the road surface.

FIGS. 6 and 7 also illustrate an aspect of control over the amount of primer spray applied by the applicator 100. In particular, applicator 100 includes a speed sensor 208 with integral display. In embodiments, the speed sensor 208 determines a speed at which the applicator 100 is moving based on, e.g., encoder readings that measure wheel rotation magnets embedded along a portion of one of the wheels. Based on the speed at which the applicator 100 is moving, the spray output of the spray nozzle 152 can be adjusted (manually or automatically) by varying the voltage supplied to the peristaltic pump 150 to provide an even or uniform application of the adhesive primer. Further control over the spray output can be provided using a voltage dial 210 contained on the control panel 196 that controls the voltage supplied to the peristaltic pump 150. In embodiments, the voltage dial 210 can be manually adjusted by the operator based on a visual output of the speed sensor 208. In an alternate or additional setting, the encoder readings can be used to automatically control the spray output. For example, the amount of primer applied could be varied based on the walking speed of the operator sensed using the encoder readings. Further, this function could include an override switch for instances where more or less primer is needed.

FIG. 6 also depicts a “deadman” switch 220 on a handle 194 of the handlebar 192. The operator is required to squeeze the switch 220 to spray primer from the applicator 100. Such switches 220 allows for better stop/start control and prevent the applicator 100 from spraying when unattended. The control panel 196 also includes an on/off switch depicted as push button 222. This push button 222 is the primary on/off switch on the control panel 196 and allows the operator a single main switch with which to turn the electronics on and off. This allows, e.g., the changing of a discharged battery 182 with a charged battery without the applicator 100 starting up on its own.

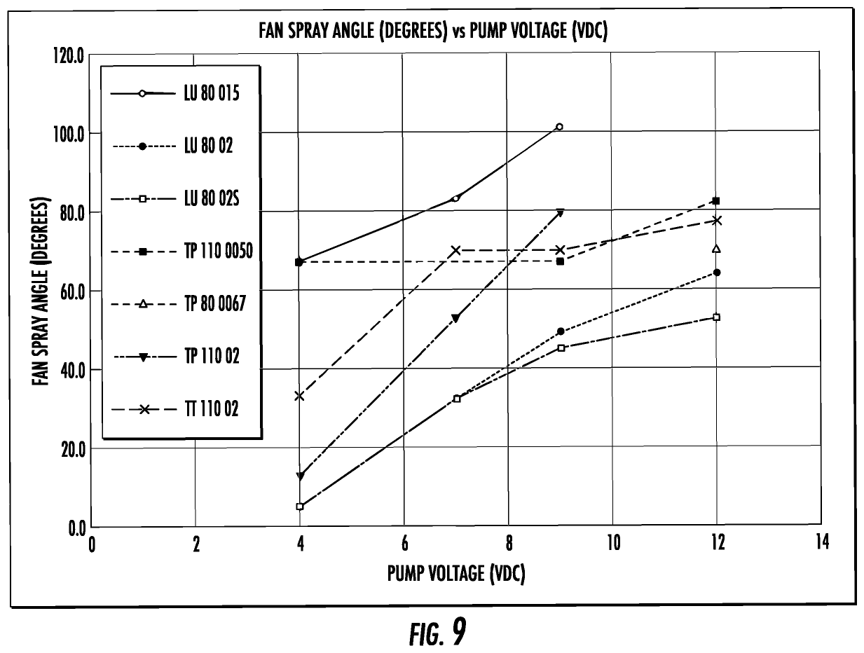

Referring now to FIG. 8, graphs of spray output as a function of voltage supplied to the peristaltic pump 150 are provided. FIG. 8 demonstrates that the spray nozzle 152 must be selected to allow for variable spray output. For the graph generated in FIG. 8, five different spray nozzles 152 were investigated to see how pump voltage (4 VDC, 7 VDC, 9 VDC, and 12 VDC) affected spray output (ml/min). Each of the spray nozzles was designed to output a flat fan spray pattern an angle of 80° or 110°. The spray nozzles 152 had orifices with a variety of different sizes based on a rated output at a given pressure. For example, TeeJet TP110 0050 has a nominal 110° flat fan spray pattern and outputs 0.05 gallons per minute (GPM) at 40 psi pump pressure. The TeeJet 110 02 also has a nominal 110° flat fan spray pattern but outputs 0.2 GPM at 40 psi pump pressure. As will be discussed more fully below, the nominal spray pattern did not correspond to the actual spray pattern as measured for output of the adhesive primer. The TeeJet TP110 02 has a larger orifice than the TeeJet TP110 0050 based on the GPM rating.

As can be seen in FIG. 8, spray tips with the smaller orifice openings provided essentially no change in the adhesive primer output rate as a function of applied voltage to the peristaltic pump 150 (TeeJet TP1100 050, TeeJet TP80 0067, and TeeJet TT110 01VP). This indicates that the spray nozzles restrict the flow passage of the liquid at 4 VDC, are operating at full pump backpressure, and that increasing the applied voltage provides no additional volume output. Spray nozzles 152 with larger orifice openings (Lechler LU80-015 and TeeJet TP 110 02) provide increased primer adhesive output as a function of applied voltage to the pump. However, at pump voltages below 7 VDC, the spray pattern of the larger orifice spray nozzles 152 was not acceptable as shown in FIG. 9.

In particular, FIG. 9 shows the flat fan spray pattern angle as a function of pump voltage. For the larger orifice spray nozzles (e.g., TT110 02, TP110 02, LU 80 02, and LU 80 025), the spray angle was relatively narrow below 7 VDC. The flat fan spray pattern angle for the smaller orifice spray nozzles (e.g., LU 80 015, TP110 0050, and TP80 0067) is much broader than for the larger orifices despite, in some instances, having the same nominal flat fan spray angle. Further, the inventors found that the nominal spray angle (which is measured for water as the output) was about 75% lower when the output was the adhesive primer. Thus, a spray nozzle having a nominal flat fan spray pattern of 110° would actually exhibit a flat fan spray pattern of about 80° when adhesive primer was output.

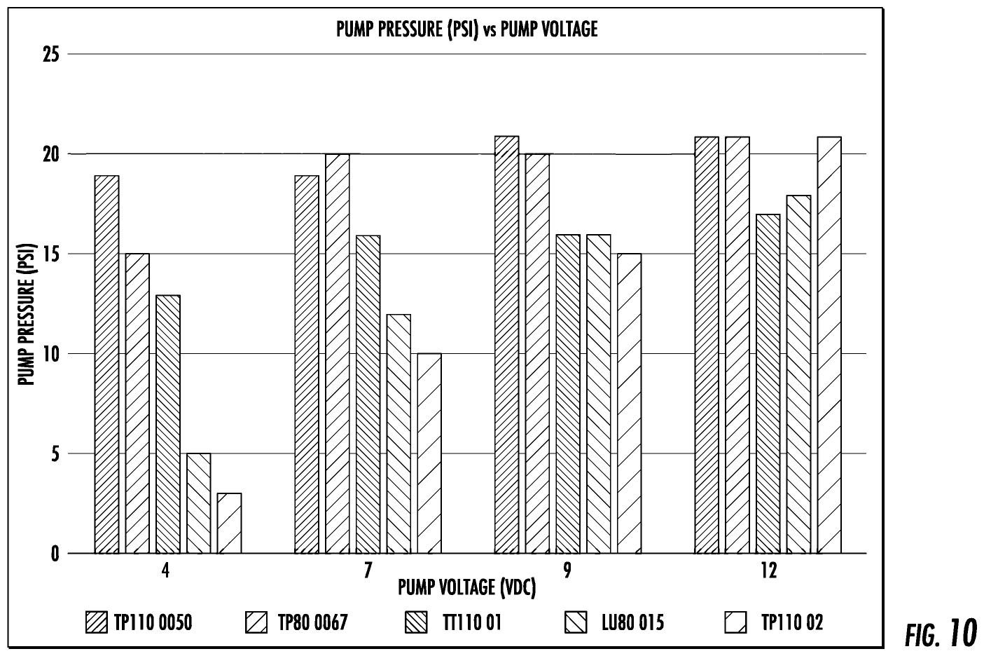

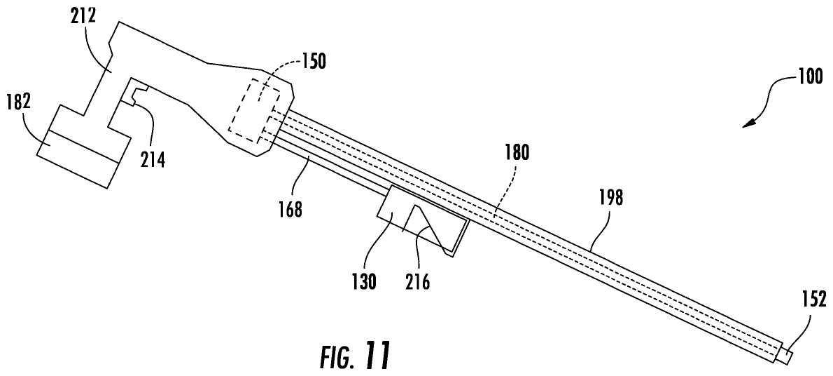

FIG. 10 depicts a graph of pump pressure for a variety of spray nozzles based on pump voltage. The spray nozzles considered were the TP110 0050, TP80 0067, TT110 01, LU80 015, and TP110 02. In the graph, for each voltage, the spray nozzles are arranged in order of smallest orifice to largest orifice going left to right. As can be seen, the pump pressure for the larger orifice nozzles lagged behind the pump pressure for the smaller orifice nozzles, especially at lower voltages. Indeed, at the lowest voltage (4 VDC), the two largest spray nozzles did not atomize a fan spray, and the output was only a narrow stream. At 7 VDC, the largest spray nozzles started to output fan spray. Based on this observation, it was determined that the larger orifice spray nozzles needed a pump pressure of at least 10 psi to produce fan spray. Also, at 7 VDC, the two smallest orifice spray nozzles were already operating at pump pressure capability (20 psi). At the highest voltage (12 VDC), each of the spray nozzles had a pump pressure above 15 psi.

The peristaltic pump used to conduct the experiments that generated the graph data in FIGS. 8-10 was Greylor RF-100, which is suitable for use in the presently disclosed applicators 100. Advantageously, this pump can be provided with a variable speed power pack that allows for the voltage (DC) to be varied at 3 V, 4.5 V, 6 V, 7.5 V, 9 V, or 12 V, and the pump provide up to 15 PSIG pressure.

As discussed above, a variety of spray nozzles were used in the experiments and are suitable for use in the presently disclosed applicators 100 (although, power supply and pump pressure may need to be matched to the spray nozzles depending on the application). In embodiments, the spray nozzle 152 provides a flat fan spray pattern in which the fan is angled at 65° to 110° (actual flat fan spray pattern for the adhesive primer). The spray nozzle 152 can be made of any of a variety of materials, including ceramic, polymer, stainless steel, or brass. Further, in embodiments, the spray nozzle 152 includes an orifice configured to output from 0.05 GPM to 1.5 GPM. As mentioned above, the nominal performance properties are based on water as the reference fluid, and it was determined that the actual fan spray pattern angle was reduced to about 75% of the nominal fan spray pattern angle. The reduction in fan spray pattern angle may be attributed to the higher viscosity of the adhesive primer (10-50 cP) as compared to water (0.89 cP). Further, the adhesive primer is less dense than water (0.74 g/mL for adhesive primer vs. 1 g/mL for water). Based on the foregoing discussion, particularly preferred spray nozzles for use with the applicator 100 are TP 80 02 VP and LU 80 02, which are polymer tips. These tips are relatively inexpensive and can be discarded instead of cleaning with a heptane flush. The nominal flat fan spray pattern angle of 80° is reduced to about 65° for the adhesive primer, which allows the tip to be positioned about two inches from the road surface, minimizing wind disruption and providing broad enough width coverage (about 2.5 to 3 inches). Using the Geylor RF-100 peristaltic pump driven at 12 VDC, the 0.2 GPM rating of the two preferred spray nozzles provides sufficient coverage (about 2 g/ft to 3.5 g/ft) when the applicator 100 is pushed at a speed of about 45 yards/min, which is a typical walking speed for operation of the applicator while maintaining alignment of the nozzle spray with a target area on the roadway. In embodiments in which the applicator is automatically steered (e.g., using a vision system), the applicator may operate at a faster speed, such as 90 to 100 yards/minute. However, the voltage could be dropped to 9 VDC, and the applicator 100 could be pushed at a slower pace. Conversely, the pump could be overdriven at 15 VDC, and the pace at which the applicator 100 is pushed could be quickened while still provided a desirable level of adhesive primer output.

FIG. 11 depicts an embodiment of an applicator 100 that is a handheld device. In particular, the applicator 100 includes a handheld wand 198 having a handle 212. As can be seen in FIG. 11, the handle 212 includes a dock for the battery 182, and the peristaltic pump 150 is mounted to a side or within a housing of the handheld wand 198. The spray nozzle 152 is arranged at an end of the handheld wand 198, and a tank 130 is also mounted to the handheld wand 198. The first conduit 168 extends from an interior of the tank 130 to the peristaltic pump 150, and the second conduit 180 extends from the peristaltic pump 150 to the spray nozzle 152. As shown in FIG. 11, the second conduit 180 extends within a bore defined by the handheld wand 198. Using a finger trigger 214, power is provided to the peristaltic pump 150 to draw adhesive primer from the tank 130 for application by the spray nozzle 152. As can be seen in FIG. 11, the tank 130 is held in a cradle 216 attached to the handheld wand 198. The handheld applicator 100 has the advantage of being relative small and portable compared to the embodiment of the applicator 100 shown in FIGS. 1-7. In this way, the handheld applicator 100 may be more maneuverable than the push applicator 100.

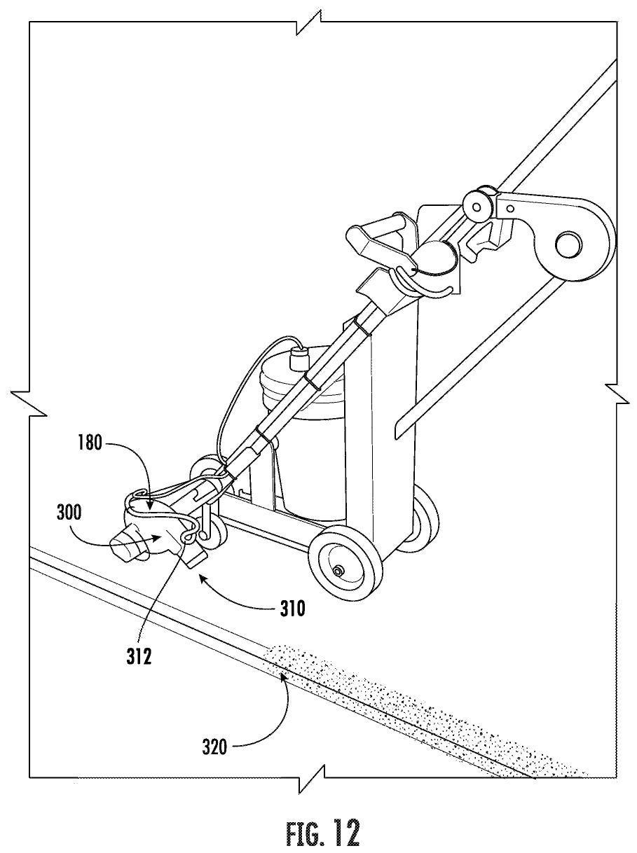

FIG. 12 depicts an additional method and apparatus for applying primer adhesive in accordance with yet other aspects of the present disclosure. The applicator 100 depicted in FIG. 12 has many of the same features described above, with some of the differing features being described below. In some cases, a water-based primer may be desirable for application. However, the water-based primer clogs easily when applying with a spray nozzle 152 through an orifice diameter below 0.017 inches, for example. Using spray nozzles or tips with a water-based primer generally leads to increased atomization and formation of a skin layer of solidified primer on or in the spray nozzle, leading to disruption of flow. The alternative method shown in FIG. 12 is to apply a water-based primer using the peristaltic pump 150 as described above, but allow for the primer to exit the secondary conduit 180, which may be a plastic or metal tube, with no change in the diameter of the conduit or tubing orifice (i.e., no spray nozzle 152). As shown in FIG. 12, the secondary conduit 180 may be a tubing having a ¼ inch inner diameter, although tubing in the range of 1/16 inch diameter to 1 inch diameter may be used depending on the application. The addition of a high velocity, forced air device 300 (similar or same in structure and function as a small leaf blower) around the conduit 180 changes the fluid flow pattern at the device exit 310 of the forced air device 300 from, for example, a ¼ inch flow (if using a ¼ inch conduit 180) to 3″ to 4″ wide fluid pattern 320 on the road. As shown in FIG. 12, the secondary conduit 180 may be directed into the air path of the forced air device 300 through an orifice 312 made in the structure of the forced air device 300. The primer is released into the air stream of the forced air device 300 such that the combined primer and air fluid is propelled from the device exit 310 at a fan out pattern and propelled to the pavement. The peristaltic pump 150 speed controls the volume of primer applied per foot travelled. The rate of primer volume can be adjusted to match the speed of the applicator 100 as it moves during application. The air speed of the forced air device 300 remains constant and independent of the primer volume application (ml per minute). Any unevenness of primer volume is equalized across the grind recess at the final step. The final step is to apply additional air flow (120 mph to allow for the excess water in the primer to be evaporated and create a dry primer surface for subsequent application of a road adhesive tape as described below.

One particular use for which the presently disclosed applicators 100 are suitable relates to installation of optical fiber cables in shallow trenches along roadways (such as trench 230 shown in FIG. 1). In such applications, a trench 230 having a central depression 232 is formed in the roadway. One or more optical fiber cables are inserted into a depression of the trench, and a road adhesive tape is provided in the trench over the depression. In this way, the road adhesive tape may be made substantially flush with the surrounding road surface. When forming the trench, the rocks and other aggregate in the concreate or asphalt are ground into a powder. In order to provide good adhesion between the road adhesive tape and the trench surface, the adhesive primer is applied in the trench using the applicator 100. The inventors have found that the adhesive primer essentially heals the aggregate in the trench in a way that provides a better bonding surface than if the dust and debris were removed from the trench using high pressure air or water.

In this regard, a trench formed in the roadway may have a width of 2.25 inches, and a trench formed in the sidewalk may have a width of 1.25 inches. The primer spray pattern is adjusted to be slightly wider than the trench to insure full coverage of the trench area with primer. In versions of the applicator 100 that are manually steered, such as the embodiments described above, the operator aligns the spray to the roadway trench. Because of the narrowness of the trenches (1.25 inches or 2.25 inches), some margin is provided to ensure full coverage of the trench, although such margin is preferably minimized to avoid wasting primer. In embodiments, the primer applicator 100 is instead automatically steered using vision system, which would allow reduced spray width to substantially match the trench width, thereby minimizing wasted primer spray.

Conventional devices that may be used to apply the adhesive primer require cleaning after use so that the adhesive primer does not create a tacky surface within the devices. In particular, the adhesive primer contains organic solvents that evaporate, leaving behind a tacky residue that diminishes device performance. In order to avoid this issue, the device needs to be flushed with a solvent. Typically, the flushing is performed using sequential flushes of heptane, but this requires a large amount of heptane (e.g., about 10 gallons of heptane for a single procedure). Storing, transporting, and disposing of the used heptane is difficult and costly. According to the present disclosure, this problem is solved by making all components that come in contact with the adhesive primer disposable. This includes the first conduit 168, the pump conduit 178, the second conduit 180, the first connector 174, the second connector 176, and the spray nozzle 152. Advantageously, each of these components are relatively inexpensive to purchase, especially relative to the cost of the heptane required for the flushing procedure. Moreover, the adhesive primer residue and applicator components are not hazardous to dispose and do not require any special handling or safety equipment to manipulate. The use of the disposable tubing is made possible, at least in part, by employing a peristaltic pump in the applicator design. Advantageously, the applicator so designed is relatively lightweight yet robust in construction and can be powered with commercially available batteries (e.g., 12, 18, or 24 V rechargeable batteries, such as Li-ion batteries) associated with electric hand tools.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An applicator for an adhesive primer, comprising:
a tank configured to hold the adhesive primer;
a peristaltic pump comprising an inlet and an outlet;
a spray nozzle;
wherein a first conduit extends from an interior of the tank to the inlet of the peristaltic pump; and
wherein a second conduit extends from the outlet of the peristaltic pump to the spray nozzle.

2. The applicator of claim 1, wherein the tank, the peristaltic pump, and the spray nozzle are carried on a base having a plurality of wheels.

3. The applicator of claim 2, wherein the spray nozzle is detachable from the base and wherein the spray nozzle comprises a handheld wand.

4. The applicator of claim 1, wherein the spray nozzle is configured to spray the adhesive primer in a flat fan pattern.

5. The applicator of claim 4, wherein the flat fan pattern has an angle of 65° to 110°.

6. The applicator of claim 1, wherein the first conduit and the second conduit are one continuous conduit extending from the tank, through the peristaltic pump, and to the spray nozzle.

7. The applicator of claim 1, wherein the first conduit is attached to a first connector disposed in the inlet of the peristaltic pump, wherein the second conduit is attached to a second connector disposed in the outlet of the peristaltic pump, and wherein a pump conduit connects the first connector to the second connector within the peristaltic pump.

8. The applicator of claim 1, wherein the first conduit and the second conduit comprise at least one of silicone tubing, polyethylene tubing, nitrile rubber tubing, neoprene rubber tubing, or polytetrafluoroethylene tubing.

9. The applicator of claim 1, wherein the spray nozzle includes an orifice configured to output from 0.05 GPM to 1.5 GPM.

10. The applicator of claim 1, wherein the spray nozzle is surrounded by a wind guard comprising a partial conical wall having a cutout through which the spray nozzle is able to be viewed during operation of the applicator.

11. A method of applying adhesive primer to a road surface using an applicator comprising a tank, a peristaltic pump, and a spray nozzle, the method comprising:
pumping the adhesive primer from the tank containing the adhesive primer through the peristaltic pump to the spray nozzle;
spraying the adhesive primer from the spray nozzle onto the road surface while the applicator moves across the road surface.

12. The method of claim 11, wherein the tank, the peristaltic pump, and the spray nozzle are carried on a base comprising a plurality of wheels and wherein the method further comprises pushing the applicator over the road surface while pumping and spraying the adhesive primer.

13. The method of claim 12, wherein the spray nozzle is detachable from the base, wherein the spray nozzle comprises a handheld wand, and wherein the method further comprises grasping the handheld wand, detaching the spray nozzle from the base, and spraying the adhesive primer from the spray nozzle while grasping the handheld wand.

14. The method of claim 11, wherein the applicator is a handheld wand, wherein the tank, the peristaltic pump, and the spray nozzle are carried on the handheld wand, and wherein spraying is performed while an operator holds the handheld wand.

15. The method of claim 11, further comprising adjusting a voltage supplied to the peristaltic pump to change an output rate of the adhesive primer.

16. The method of claim 15, further comprising sensing a speed at which the applicator moves across the surface and wherein the step of adjusting the voltage is performed in response to the speed of the applicator sensed.

17. The method of claim 11, wherein the adhesive primer is pumped through a single conduit from the tank, through the peristaltic pump, to the spray nozzle.

18. The method of claim 17, wherein, upon completion of the spraying, the single conduit and the spray nozzle are disposed of without cleaning.

19. The method of claim 11, wherein the adhesive primer is pumped through a first conduit from the tank to an inlet of the peristaltic pump, through a pump conduit from the inlet to an outlet of the peristaltic pump, and through a second conduit from the outlet to the spray nozzle.

20. The method of claim 19, wherein, upon completion of the spraying, the first conduit, the pump conduit, the second conduit, and the spray nozzle are disposed of without cleaning.
